(19) United States
(12) Patent Application Publication
(10) Pub. No.: US 2025/0381630 A1
(43) Pub. Date: Dec. 18, 2025

(54) MECHANICAL TRIMMING TOOL FOR A DEVICE SUSPENDED FROM A STRUCTURE BY TWO MOUNT POINTS

(71) Applicant: Exposure Illumination Architects, Inc., Scottsdale, AZ (US)

(72) Inventor: Daniel S. SPIRO, Scottsdale, AZ (US)

(73) Assignee: Exposure Illumination Architects, Inc., Scottsdale, AZ (US)

(21) Appl. No.: 18/903,045

(22) Filed: Oct. 1, 2024

Related U.S. Application Data
(63) Continuation-in-part of application No. 18/742,254, filed on Jun. 13, 2024.

(51) Int. Cl. B23P 19/04; F21V 21/008

(52) U.S. Cl. CPC B23P 19/04; F21V 21/008

(57) ABSTRACT

A trimming tool is used to help in the installation of a suspended device, such as a luminaire. The tool is used for suspending, plumbing, and trimming a device coupled at a specified mounting elevation by a suspension cable coupled to two support mounting points above The tool includes an elongated horizontal structure with vertical extension members positioned at the elongated horizontal structure opposite ends, wherein the vertical extensions terminate at each end with a substantially horizontal tab. The tool also includes a depressible bar, a latching device, and a suspension cable coupled to at least two couplers that are mounted to a device below.

### CROSS-REFERENCE TO RELATED APPLICATION

The present application is a continuation-in-part of U.S. application Ser. No. 18/742,254, filed Jun. 13, 2024, which has common inventorship with, and contains subject matter related to that disclosed in U.S. patent application Ser. No. 18/401,448, U.S. patent application Ser. No. 18/433,140, U.S. patent application Ser. No. 18/436,081 the entire contents of each of which being incorporated herein by reference.

### BACKGROUND

### Technical Field

The present disclosure relates to a mechanical trimming tool that enables suspending a device from two mounting points above to a specified mounting height while maintaining the device trimmed and plumbed. More particularly, the tool is for use in suspending, plumbing, and trimming a device coupled at a specified mounting elevation by a suspension cable coupled to two support mounting points above.

### Discussion of Background

Devices suspended from an overhead structure (e.g., lights in a warehouse) are commonly suspended by a conduit, pendent, cord, chain, and/or a cable. Small devices are typically suspended by a single suspension element. Larger devices, odd shaped devices, and orientation specific devices often are suspected with a plurality of suspension elements. The suspended devices are typically required to be installed so as to be plumbed at a uniform mounting height. Furthermore, to satisfy aesthetic requirements to provide structural stability, devices with asymmetrical forms can be required to have a particular orientation such as parallel to the floor, or some other fixed angle of suspension with respect to the floor or ceiling.

Recent innovations in the field of building illumination have resulted in a new class of luminaires referred to as “orientation specific luminaires”. These luminaire classes require suspension from a support structure by at least two mounting points. This new luminaire class has given rise to a need, as recognized by the present inventor, for an installation tool that is configured to help expedite the mounting, plumbing and trimming of the orientation specific luminaire.

Today, as discussed in U.S. patent application Ser. No. 18/436,081, luminaire optics can be agnostic of the luminaire's physical form while directing light in an asymmetrical pattern onto vertical and/or horizontal surfaces. In addressing the luminaire's specific orientation needs, at least one orientation specific hub has been invented (see U.S. patent application Ser. No. 18/433,140) by the present applicant. The orientation specific hub can be coupled to a mechanical or an electromechanical device such as a luminaire. In at least one different embodiment, the orientation specific hub can be coupled to a luminaire/device support structure or a combined coupling to the support structure above and the suspended luminaire/device below.

The orientation specific device has introduced a new device concept for the construction industry. However, as recognized by the present inventor, the concept of the new device raises questions about means and methods of construction including establishing device mounting height, handling device weight, number of installers required for a device installation, and the production time for the device installation. Important factors to the efficiency of device mounting production include the device trimming, plumbing, and orientation. The present application shows and teaches of a tool called Mechanical Trimming Tool (MTT) that is configured in most two point mounting applications to enable a single installer mount a device from a support structure above. Moreover the present disclosure teaches and shows mechanical solutions that, in general, further simplify the installation process of the MTT, and specifically the trimming of a suspension cable that supports the weight of a mechanical or electromechanical device that is suspended by a single cable from two support mounting points.

### SUMMARY

The present disclosure shows the structures and teaches the use of a tool called “Mechanical Trimming Tool (MTT)” that is configured for most two point mounting applications to enable a single installer to mount a device from a support structure overhead.

The MTT enables an installer to lift/lower a cable suspended device to a specified mounting height, level the coupled device, trim the cable, and discard excess slack. Upon completion of the installation, the MTT can be removed and can be used again in mounting other devices.

Through the installation process, the MTT is positioned below a support structure and above a coupled device. Laterally, the MTT is wedged between two cable sections originating at two mounting points (or more) above and extending down and through the MTT to at least two suspended device fasteners below. The entire assembly can be comprised of a support structure, a cable, an MTT, and the coupled device.

The suspension cable coupled to the mounting points above is configured to be routed through and along the outward facing side surfaces of the MTT in a manner that enables the lifting and lowering of a device coupled from below with ease. Upon lifting/lowering the device at a specified mounting height, the device is plumbed and trimmed by securing two suspension cable sections to one another with cable couplers.

Through the installation of the cable suspended device, the MTT provides control over the elevational height of the coupled device. The control over the elevational height of the suspended device is attained using at least one of, a high friction surface positioned to exert pressure on a suspended cable section, and/or a protrusion. Both methods are purposed for preventing at least one of lateral and vertical mobility due to a gravity pull by the coupled suspended device.

It is noted that the MTT is also configured to couple to a device that employs orientation specific optics despite the increased complexity. In lifting a trimmed and plumbed device to a specified mounting height, the MTT is configured to do so by single vertical or vertical and lateral motion. It is further noted that suspending the device requires a single cable coupled to a support structure at two mounting points.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1a and 1b respectively show a frontal view and a side view of an assembly having a support structure, a suspended lighting device, a MTT positioned in between the support structure and the suspended lighting device, and suspension cables extending from the support structure through the MTT coupling to the lighting device below.

FIG. 2 shows a frontal elevation of the MTT with suspension cables extending through the MTT.

FIG. 3 shows a longitudinal section through the mechanical trimming tool.

FIGS. 4a and 4b show a top view and a bottom view of the mechanical trimming tool.

FIG. 5 shows a top perspective view of the mechanical trimming tool.

FIG. 6 shows a bottom perspective view of the mechanical trimming tool.

FIGS. 7a, 7b, 7c, and 7d show a step-by-step process of suspending a device from a suspension cable.

FIGS. 8a and 8b show a suspended device assembly through the course of an installation and upon completion and removal of the MTT, respectively.

FIGS. 9a, 9b, 9c, and 9d show front, top, bottom, and side elevations of the MTT, respectively.

FIG. 10a shows a longitudinal vertical section across the MTT's side of the cable grippers and FIG. 10b shows a corresponding transverse vertical section across the MTT.

FIG. 11a shows a longitudinal vertical section across the MTT's side facing the MTT's friction pressure plate and FIG. 11b shows a corresponding transverse vertical section across the MTT.

FIGS. 12a and 12b show partial enlargements of protrusions interacting with a friction pressure plate and cable gripper surfaces providing resistance against suspension cable mobility.

### DETAILED DESCRIPTION

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

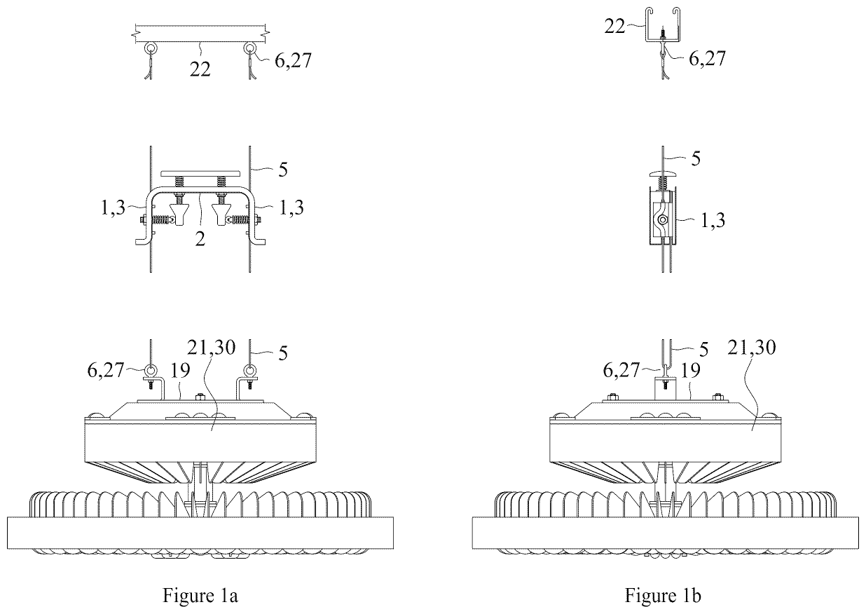

In reference to FIG. 1a and FIG. 1b, the MTT 1 is a tool that enables an installer to raise and lower a device 21, 30 (e.g., a luminaire) to a specified mounting height while the device 21, 30 remains plumb and trimmed. The MTT 1 is positioned below a support structure 22 above and a suspended device 21, 30 below. The suspended device 21, 30 can be coupled to an orientation specific hub 19. At least two mounting couplers 6 can be coupled to the surface of a device 21, 30 and/or to a surface of the orientation specific hub 19. At least one suspension cable 5 can couple the device to the support structure 22 above.

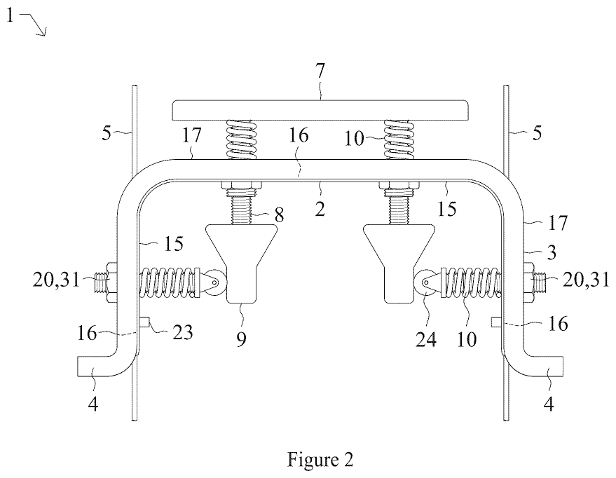

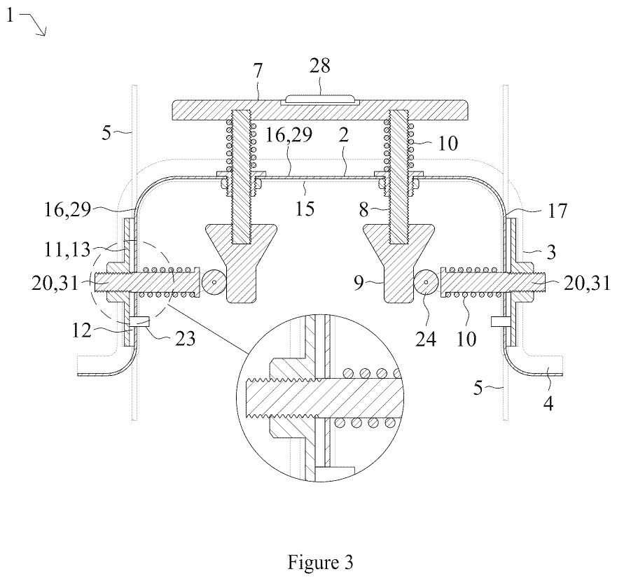

The MTT 1 includes an elongated horizontal structure 2 and vertical extension members 3 positioned at the opposite ends of the elongated horizontal structure 2 wherein the vertical extension members 3, in at least one embodiment, can terminate at each end with a substantially horizontal tab 4 (FIG. 2). In references to FIGS. 2 and 3, elements of the MTT 1 include a depressible horizontal bar 7 with at least one plunger extension 8 coupled to a plunger 9 below. The depressible bar 7 is positioned above the elongated horizontal structure 2 with a gap in between. The depressible bar 7 via the plunger 9 exerts vertical pressure on at least one mechanical pressure exerting latching device 31. The horizontally oriented mechanical pressure exerting latching device 31 converts the vertical pressure received to lateral pressure that is applied on the latching devices 11 pressed against the exterior side surfaces 29 of the vertical extension members 3. In a different embodiment (not shown) at least one protrusion with or without the latching device can apply pressure on at least one suspension cable in such manner that the suspension cable has a fold thus causing friction that stop the vertical mobility of the device coupled from below.

The MTT 1 is configured to receive at least two suspension cables 5 from a support structure 22 above. A separation distance for mounting points for the cables 5 at the support structure 22 can be the same as the distance between the suspension cables 5's openings adjacent to the exterior side surfaces 29 of the vertical extension members 3. The suspension cables 5 extend downwardly through the openings adjacent to the vertical extension members 3. The suspension cables 5 continue extending downwardly through couplers 6 (e.g., FIG. 1a) that can be coupled directly or indirectly by means of an orientation specific hub 19 to a device 21, 30 below.

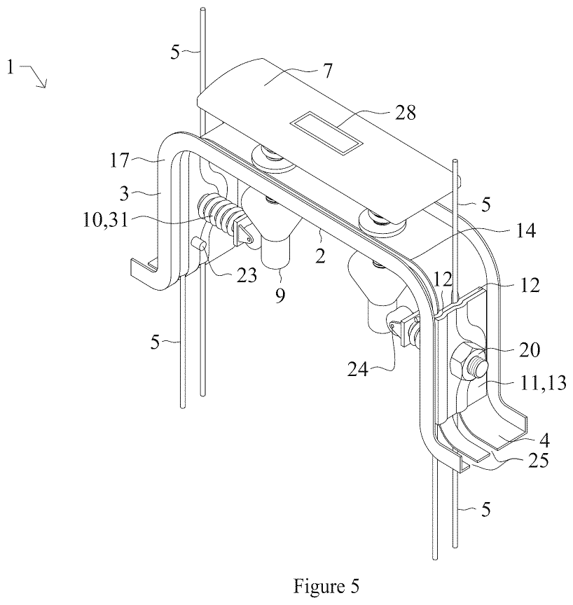

The suspension cables 5 exit the couplers 6 from another side, and then extend upwardly, entering different openings at the bottom of the mechanical trimming device 1. The section of the suspension cable 5 then extends upwardly through openings at the bottom of the MTT continuing along the exterior side surfaces 29 of the vertical extension members 3 and resting on the elongated horizontal structure's exterior side surface 29. In at least one embodiment, at least one channel 14 (e.g., FIG. 5) can be formed in at least one exterior side surface 29 of the mechanical trimming tool 1 to seat at least one suspension cable 5.

The MTT I can employ at least one depressible horizontal bar 7 with at least one vertical plunger extension 8 coupled below the elongated horizontal structure 2. A gap between the depressible bar 7 and the top surface of the elongated horizontal bar 2 is maintained by a pressure exerting device 10 disposed between. The pressure exerting device 10, e.g., as implemented with a spring, may impart may exert pressure from a resilient force imparted by the pressure exerting device 10. With pressure applied on the depressible horizontal bar 7, the plunger 9 moves downward exerting vertical pressure on a mechanical pressure exerting latching device 31 that in turn converts the applied pressure to lateral pressure that maintains coupled latching devices' 11 pressure against the exterior side surfaces 29 of the vertical extension members 3.

At the exterior side surfaces 29 of the vertical extension members 3, the mechanical pressure exerting latching device 31 is coupled to a latching device 11 that has a hardened backing surface 13 with non-slip material 12 coupled thereto. The hardened backing surface 13 can include at least one coupled guiding leader 23 that prevents the latching device 11 from rotating. The non-slip material 12 coupled to the hardened backing surface 13 is configured to maintain constant contact with the exterior side surface 29 of the vertical extension members 3 with the suspension cables 5, received from above and below, positioned in between. The pressure applied on the suspension cables 5 keeps the suspended device 21, 30 stationary.

Elevating or lowering the coupled device 21, 30 below is accomplished by applying downward pressure on the depressible bar 7. In reaction, the depressible bar plunger 9 then exerts pressure on a roller 24 that is coupled to mechanical pressure exerting latching devices that in turn open gaps between the latching device 11 non-slip material 12 surface and the exterior side surface 29 of the vertical extensions. In at least one embodiment, at least one of the profiles of the non-slip material 12 surface and the profile of the exterior side surface 29 of the vertical extension member 3 can have a channel 14 that is sized to enable maximum contact with a suspension cable 5 disposed between.

As described in the above example, the MTT allows for a suspended coupled device 21, 30 to remain stationary. The mechanisms of maintaining the coupled device 21, 30 stationary can vary; however, regardless of the mechanism to keep a coupled device stationary, the present innovation's utilities include at least one of:
a) A tool for trimming and plumbing a suspended device that is configured to lift and lower a suspended device by exerting pressure on a tool's lever.
b) A tool that enables lifting/lowering a suspended device to a specified mounting height, trimming, and plumbing in a one step process.
c) A way of trimming and plumbing a suspended device from two support mounting points above with a single suspension cable.
d) A way of trimming and plumbing a suspended device from two mounting points of an above support structure and two device mounting points on a device below wherein the device orientation remains permanent.
e) A tool for trimming and plumbing a suspended device wherein the tool is portable and reusable for trimming and plumbing with at least one other device.
f) A tool for trimming and plumbing a suspended device wherein the tool enables the installation process of the device to be accomplished by a single installer.

Upon trimming and plumbing a coupled suspended device at a specified mounting height, the last step includes securing the suspended cables to one another above each coupler. Securing the cables to one another can be accomplished by at least one aircraft cable fastener. Once secured in place, the cable section extending across the mechanical trimming tool can be cut and discarded. The mechanical trimming tool can be reused again.

### DETAILED DESCRIPTION WITH REFERENCE TO DRAWINGS

FIG. 1a shows an assembly having a support structure, a suspended lighting device, a MTT positioned in between, and suspension cables extending from the support structure through the MTT down, coupling to couplers that are coupled to a lighting device.

The suspended assembly shows a support structure 22 with two eye loop 27, as coupling devices 6, set apart from one another. Suspension cables 5 coupled to respective of the pair of eye loops 27 (also referred to as coupling devices 6) extend through openings in the mechanical trimming device 1 downwardly to couple to reciprocating eye loops 27 that are coupled to an orientation specific hub 19. The orientation specific hub 19 is shown coupled to a light emitting device 30. In a different embodiment, the coupling devices 6 couple directly to a surface of a device 21 below.

The mechanical trimming tool 1 can be coupled to the suspension cables 5 after a mechanical or an electromechanical device 21 is coupled. The suspension cable 5 can be a continuous cable that passes from one side of the MTT to the other as will be discussed in more detail below. The suspension cable 5 can originate from a first coupling device 6, 27 mounting point of the support structure 22, extending through one end opening of the mechanical trimming tool I adjacent to one side of a vertical extension member. The suspension cable then extends downwardly through a coupler 6 passthrough opening, exiting at the other side and then extending upwardly through a different opening at the bottom side of the mechanical trimming tool 1. The suspension cable then extends upwardly along the exterior surface of a vertical extension member 3 and the exterior surface of the elongated horizontal structure 2, and then extends downwardly along the exterior surface of the opposing side's vertical extension member 3. The suspension cable then exits an opening at the bottom of the vertical extension member, extending downwardly entering a passthrough opening of a different coupler 6. The suspension cable 5 then exits the coupler 6 at the other side, and extends upwardly through an opening at the bottom side of the mechanical trimming tool 1. Finally, the suspension cable 5 extends upwardly, adjacent to the vertical extension member 3 and connects to and along the exterior surface of the vertical extension member 3 to couple to a second coupling device mounting point 6, 27 of the support structure 22. A recommended distance between the suspension cables should be no less than the distance between the couplers 6 coupled to the device below.

FIG. 1b shows the same assembly as shown with FIG. 1a with the assembly rotated at 90°. Elements shown include: the support structure 22, the coupler 6, 27, the mechanical trimming tool 1, the suspension cable 5, the vertical extension member 3, the orientation specific hub 19, and the device/light emitting device 21, 30.

FIG. 2 shows a frontal elevation of the mechanical trimming tool 1 with suspension cables 5 extending through from above as well as from below. Moreover, FIG. 2 shows the mechanical trimming device 1 having three distinct sections: an elongated horizontal structure 2, vertical extension members 3, and tabs 4. The tabs 4 are not essential for the operation of the mechanical trimming tool. However, they can be useful in guiding the suspension cables 5 to their respective locations.

The pair of suspension cables 5 enter passthrough openings from above at opposite sides of the mechanical trimming tool 1. The suspension cables extend downwardly looping through coupling devices (discussed above with respect to FIG. 1a) extending upwardly to enter different passthrough openings from below at opposite sides of the mechanical trimming tool 1. During installation, two suspension cables 5 enter the mechanical trimming tool 1 from above and four suspension cables from below. Two of the four suspension cables entering from below wrap around the surfaces of the exterior sides 16 of the vertical extension members 3 and the elongated horizontal structure 2.

The mechanical trimming tool 1 material is sufficiently strong to execute the trimming or trimming and plumbing operation effortlessly. To increase rigidity, stiffeners 17 at both sides of the tool form a “U” shaped beam. A height and/or thickness and/or material of the stiffener 17 can correspond to offset the weight of the device coupled below.

Above the elongated horizontal structure 2 a depressible bar 7 shown is configured to enable retaining a device suspended below to remain stationary, until fasteners (not shown) secure device suspension cables 5 in place. Before the fasteners are installed, the depressible bar 7 enables setting the suspension cables 5 in place along the exterior surfaces of the mechanical trimming device 1 and raising/lowering the coupled device to its permanent mounting height.

Undisturbed, the depressible bar 7 extends above the elongated horizontal structure 2. FIG. 2 shows pressure exerting devices 10 in the form of springs maintaining the gap. In other embodiments, the gap can be maintained by other devices, such as foam pieces that have a resilient property. The plunger extensions 8 are positioned vertically (i.e., orthogonal to a horizontal plane of the main surface of the depressible bar 7) with respect to the depressible bar 7 with plungers 9 coupled at their bottom. When downward pressure is applied on the depressible bar 7, the plungers 9 exert vertical pressure on the rollers 24 of the mechanical pressure exerting latching device 31.

The mechanical pressure exerting latching device 31 redirects the vertical pressure applied from the above plungers 9 laterally. The latching device 31 includes a threaded rod with a roller 24 at the interior side of the mechanical trimming device 1 and a latching device 11 (not shown) at the opposite side being the exterior side 16 of the vertical extension members 3. The latching device assembly presses against the wall of the vertical extension member 3 from both sides and is secured by a bolt 20. FIG. 2 shows a pressure exerting device 10 in the form of a spring that maintains latching pressure on the latching device. The pressure applied by the latching device keeps the device suspended below stationary.

The latching device is disposed between the stiffeners 17 and can be formed as an elongated body. To avoid rotation, at least one guiding leader 23 built into the latching device is configured to prevent rotational mobility.

FIG. 3 shows a longitudinal section through the mechanical trimming tool. At the top of the depressible bar 7, an optional bubble level 28 is shown embedded inside the bar's handle. For reasons of brevity, the present narrative makes note of the elements described in FIG. 2 and expands on the elements and operational functionalities yet to be disclosed. The elements shown in FIG. 2 include the pressure exerting device 10, the elongated horizontal structure 2, the exterior side and surface 16, 29 of the mechanical trimming tool, the plunger extension 8, the plunger 9, the suspension cable 5, stiffeners 17, and the interior side of the mechanical trimming tool 15.

FIG. 3 also shows the elements of the mechanical pressure exerting latching devices 31. The mechanical pressure exerting latching devices 31 are horizontally oriented devices that couple the vertical extension members 3 of the mechanical trimming device 1. Each latching device 31 can comprise a threaded rod with a roller 24 at the interior side 15 of the mechanical trimming device 1 and a latching device 11 at the opposite side, being the exterior side 16 of the vertical extension members 3. The roller 24 is configured to redirect the vertical pressure applied by the plunger 9 laterally. The roller can have a recess at the contact point with the plunger 9. The latching device 11 is configured to press against the exterior wall of the vertical extension member 3 through pressure applied from inside the interior side 15. Both latching devices 11 are secured by nuts 20. FIG. 3 shows a pressure exerting device 10 in the form of a spring maintaining pressure on the latching device 11. The pressure applied by the latching device 11 on the two suspension cables 5 wedged between the latching device 11 and the exterior side surface 16, 29 of the vertical extension members' walls keeps a device suspended below stationary.

Latching devices 11 include a non-slip material 12 layer coupled to a hardened backing surface 13. The hardened backing surface 13 can include at least one guiding leader 23 that is configured to maintain the lateral and non-rotational latching device 11 movement when pressure is applied on the depression bar 7. The guiding leader 23 can extend through a bore in the wall of the vertical extension member 3. As shown, the travel distance of the latching device can be no less than the largest diameter of the suspension cable used, the gap between the side walls of the latching device 11, and the inner walls of the stiffeners 17.

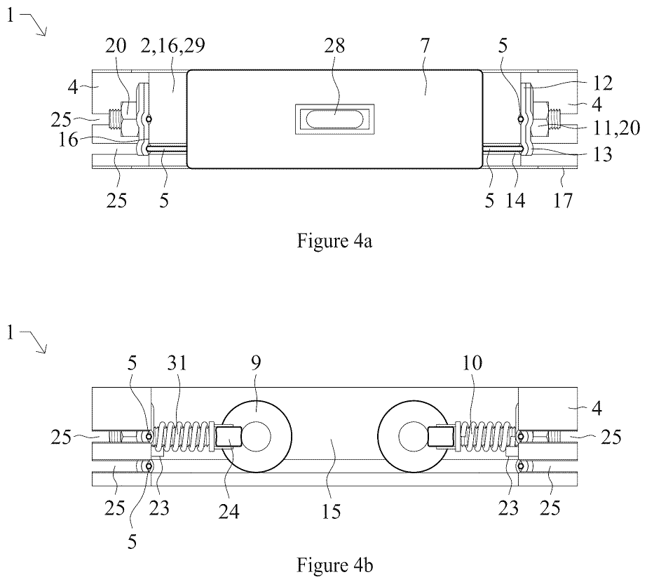

FIGS. 4a and 4b show a top view and a bottom view of the mechanical trimming tool, respectively.

FIG. 4a shows the top view of the mechanical trimming tool 1 with the depressible bar 7 above, and includes an optional bubble level 28 embedded inside the bar's handle. Below, the elongated horizontal structure 2, two parallel channels 14 are recessed in the exterior top surface 16, 29 of the horizontal structure 2 extending the longitudinal length of the elongated horizontal structure 2. At least one of the channels 14 is configured to receive a suspension cable 5 section that originates from below at both ends of the mechanical trimming tool 1.

At opposite ends of the mechanical trimming tool 1, tabs 4 with suspended cable insertion slots 25 are shown with a mechanical pressure exerting latching device 11 securing nut 20. The securing nut 20 secures the assembly including the non-slip material layer 12 coupled to the hardened backing material 13. A gap between the stiffeners' 17 inner walls and the latching device's hardened backing material 13 is configured to enable placing the suspension cable 5 between the surface of the non-slip material 12 and the exterior side surface 16 of the vertical extension member 3.

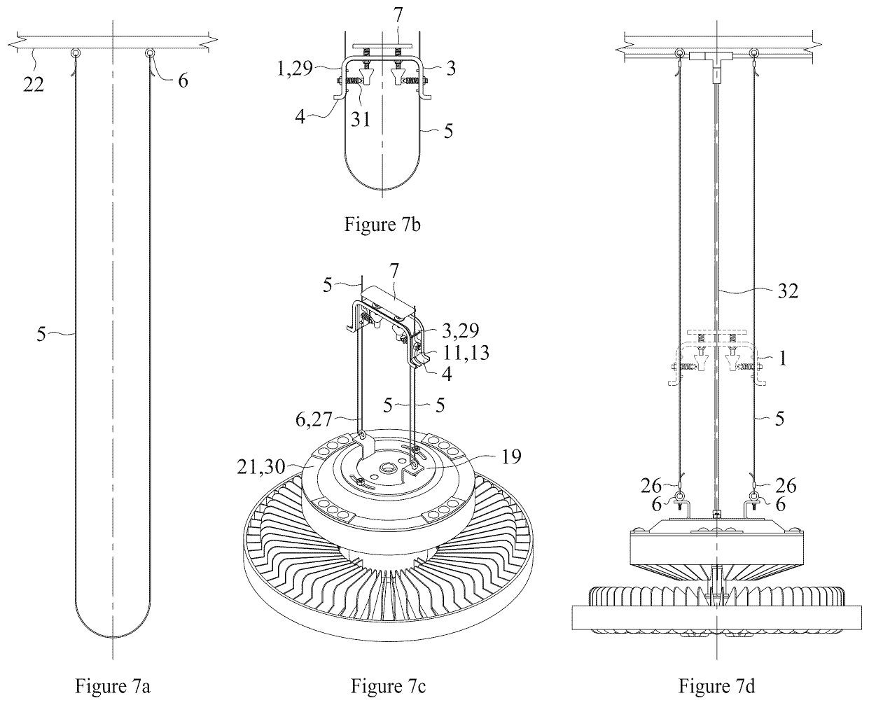

Although a detailed explanation will be provided of an installation process with reference to FIGS. 7a-d, a brief description on an aspect is provide with reference to FIGS. 4a and 4b. To insert a suspension cable 5, an installer inserts a suspension cable 5 through the insertion slot 25 and then between a stiffener's 17 inner wall and the side wall of the latching device. Then the installer places the suspension cable 5 between the non-slip material surface 12 and the exterior side wall 16 of the vertical extension member. In at least one embodiment, channel/s 14 in at least the non-slip material 12 surface and the exterior side surface 16 of the vertical extension member 3 is/are configured to receive a suspension cable 5.

FIG. 4b shows a bottom view of the mechanical trimming device 1. The bottom view shows the interior side 15 of the mechanical trimming device 1. At the center, plungers 9 are shown communicatively coupled to the rollers 24 of the mechanical pressure exerting latching device 31. Elements of the device 31 shown also include a pressure exerting device 10 in the form of a spring, and a latching device guiding leader 23. At the ends of the mechanical trimming device 1, the bottom side of a tab 4 is shown having two insertion slots 25 each and suspension cables 5 wedged in between the non-slip material 12 of a latching device 11 and an exterior side surface 29 of a vertical extension member 3.

FIG. 5 shows a top perspective view of the mechanical trimming tool 1. The elements shown include: a suspension cable 5, a latching device 11, a hardened backing surface 13, a nut 20, a vertical extension member 3 of the mechanical trimming tool 1, a tab 4, a plunger 9, an elongated horizontal structure 2 of the mechanical trimming tool 1, a roller 24, a mechanical pressure exerting latching device 31 with a pressure exerting device 10, a guiding leader 23, a suspension cable insertion slot 25, a stiffener wall 17, and above a depressible bar 7 with a coupled optional bubble level 28.

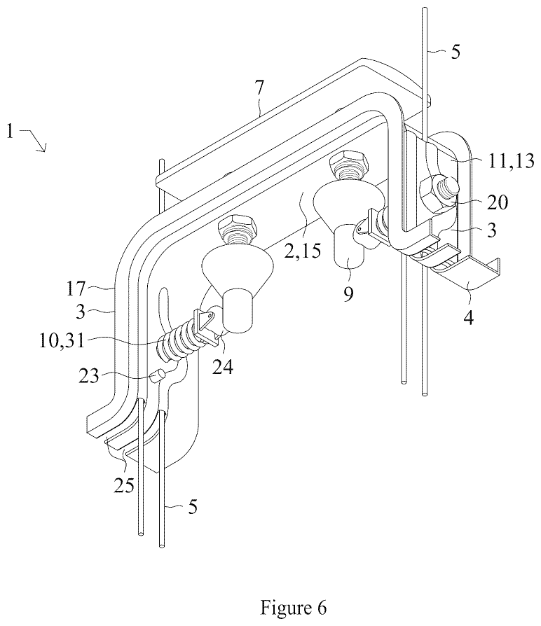

FIG. 6 shows a bottom perspective view of the mechanical trimming tool. The elements shown include: a suspension cable 5, a latching device 11, a hardened backing surface 13, a nut 20, a vertical extension member 3 of the mechanical trimming tool 1, a tab 4, a plunger 9, an elongated horizontal structure 2 of the mechanical trimming tool 1, an interior side 15 of the mechanical trimming tool 1, a roller 24, a mechanical pressure exerting latching device 31 with a pressure exerting device 10, a guiding leader 23, a suspension cable insertion slot 25, a stiffener wall 17, and above a depressible bar 7.

FIGS. 7a, 7b,7c, and 7d show a step-by-step process of suspending a device from a suspension cable.

FIG. 7a shows a suspended device elevated support structure 22 with two couplers 6 mounted to the bottom surface of the support structure 22. A suspension cable 5 coupled to a first coupler 6 extends downwardly to a height below a specified mounting height for a designated device and then extends upwardly to couple to a second coupler 6. In this regard the cable 5 is continuous.

FIG. 7b shows a partial view of the bottom section of the suspended cable 5 with a mechanical trimming tool 1 coupled. The suspended cable/s 5 can be inserted through the insertion slots of the tabs 4 and then slipped between the latching device and the exterior side surface 29 of the vertical extension members 3 at the opposing sides of the mechanical trimming tool 1. For mechanical trimming tool 1 embodiments without tabs 4, the suspension cable/s 5 can be directly placed between the latching device and the exterior surface of the vertical extension members at opposing sides of the mechanical trimming tool 1.

Placing the suspension cable 5 in place requires an installer to exert pressure on the depressible bar 7. The pressure applied forces the latching device 11 of the mechanical pressure exerting latching device 31 to open a gap, enabling the placement of the suspension cable/s 5 to be slipped into their respective positions. In at least one embodiment, at least one exterior side surface 29 of at least one vertical extension member 3 can have a channel to which at least a portion of the suspension cable 5 couples. Similarly, at least one non-slip surface of at least one latching device can have a channel that at least a portion of the suspension cable 5 couples to.

At this step of installation, the latching devices of the mechanical trimming tool 1 firmly grips the two device suspension cables 5. The remaining section of the suspension cable 5 extends downwardly.

FIG. 7c shows how the remaining sections of the suspension cable 5 are coupled to the device's 21, 30 couplers 6. The couplers 6 can directly couple to a device 21, 30 or can couple to an orientation specific hub 19 as shown in the present figure. The present figure shows two open end eye loops 27 set apart from one another. Karabiners or other connectors may be used as well as an alternative to an open loop. It is recommended, although not essential, that the distance between the couplers 6 of the device be approximately the same as the distance between the exterior side surfaces 29 of the vertical extension members' 3 surfaces.

In FIG. 7c, the remaining section of the suspension cable 5 is inserted through both open eye loops 27. The jointed section enters each of the open eye loops 27 from one side and exits from the opposite side. Then, the section of cable 5 is oriented upwardly, through the openings at the bottom sides of the tab 4, continues to extend upwardly along the exterior side surfaces 29 of the vertical extension members 3, and rests on the exterior surface side 29 of the elongated horizontal structure 2. As with the suspension cable/s received by the mechanical trimming tool 1 from above, the suspension cables received from below can have dedicated insertion slots, passthrough openings, and channels. The latching devices 11 are configured to latch to both the suspension cables 5 received from above and from below.

With the suspension cable/s 5 from the above and from the below in place and the coupled device 21, 30 couplers 6 engaged, the trimming and plumbing mechanical trimming tool 1 is ready to position the coupled device 21, 31 at a specified mounting height. The installer then lowers the mechanical trimming tool 1 to an appropriate distance above the coupled device 21, 30 while maintaining the trimming tool 1 plumb. The installer then proceeds with raising or lowering the device to a specified device mounting height. In performing this step, the latching devices 11 of the mechanical trimming tool 1 are engaged to maintain the device's plumbed position.

FIG. 7d is the last installation step. In this step the installer fastens (e.g., by use of a cable clip clamp or a cable clip) to one another the two side by side suspension cables 5 of each coupler 6, optionally cuts and discards the suspension cable 5 section that extends through and across the mechanical trimming tool 1, and removes the mechanical trimming tool.

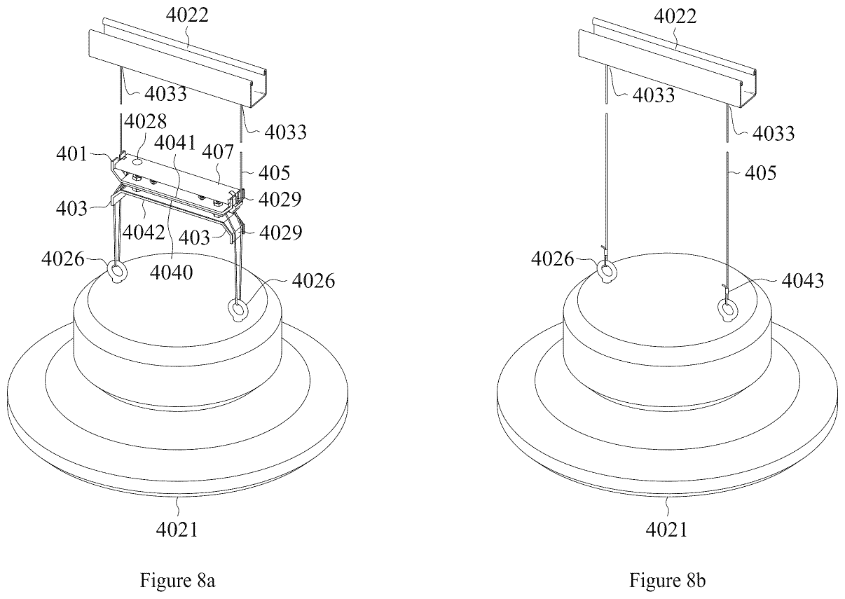

According to another embodiment, FIGS. 8a and 8b show a suspended device assembly through the course of an installation and, upon completion, removal of the MTT, respectively.

The MTT tool facilitates lifting and lowering a cable suspended device to a specified mounting height, and then plumbing the device and trimming the cable in a single perpetual motion. To do so, the cable is routed through and alongside the MTT. The MTT is provided with a way to control and restrain the suspended cable with a coupled device movement. A depressible bar positioned on top of the tool enables routing the suspension cable through the MTT. When pressure is exerted on the depressible bar, clearances open between high friction surfaces and/or protrusions, enabling an installer to lift/lower a device coupled below. When the pressure exerted is released, these surfaces apply pressure on sections of the suspension cable restraining the coupled device movement.

FIG. 8a shows a single suspended cable 405 mounted to a support structure 4022 above at two mounting points 4033. The two sections of the suspension cable 405 extend downward alongside the vertical extension members 403 of the top and bottom horizontal structures 4041, 4042. The two cable sections 405 pass through two device support fasteners 4026 and then extend upwardly toward the MTT 401. The two cable sections 405 passing through the device support fastener 4026 in the upwardly direction abut the external side surface 4029 of the vertical extension members 403 of the bottom horizontal structure 4042 to merge between the pressure friction plate 4040 and the bottom surface of the top horizontal structure 4041.

The MTT tool 401 enables an installer to position, plumb, and trim a cable suspended device 4021 at the specified mounting height with ease. Once the suspended cable 405 is routed through the device fastener 4026 and placed alongside of the MTT's 401 vertical extension member 4029, the installer, by exerting pressure on the depressible bar 407, can lift and lower the coupled suspended device 4021 to a specified mounting elevation. By releasing the pressure on the depressible bar 407, the MTT 401 locks the suspension cable 405 in place with the coupled device 4021 below.

The depressible bar 407 can optionally include a bubble level 4028 for use in leveling the coupled device 4021 below. The installer can alter the orientation of the coupled device below by introducing a rotational pressure on the MTT's 401 depressible bar 407 for the purpose of plumbing the coupled device 4021. After plumbing the coupled device 4021, the two suspended cable sections 405 shown at each opposite side of the device 4021 supporting the weight of the device 4021 below can be coupled to one another (e.g., with cable clamps), and the MTT 401 can then be removed.

FIG. 8b shows the cable suspended device assembly following the removal of the MTT. Elements shown include a support structure 4022, mounting points 4033, a suspension cable 405, a device fastener 4026, a cable coupler 4043, and a device 4021.

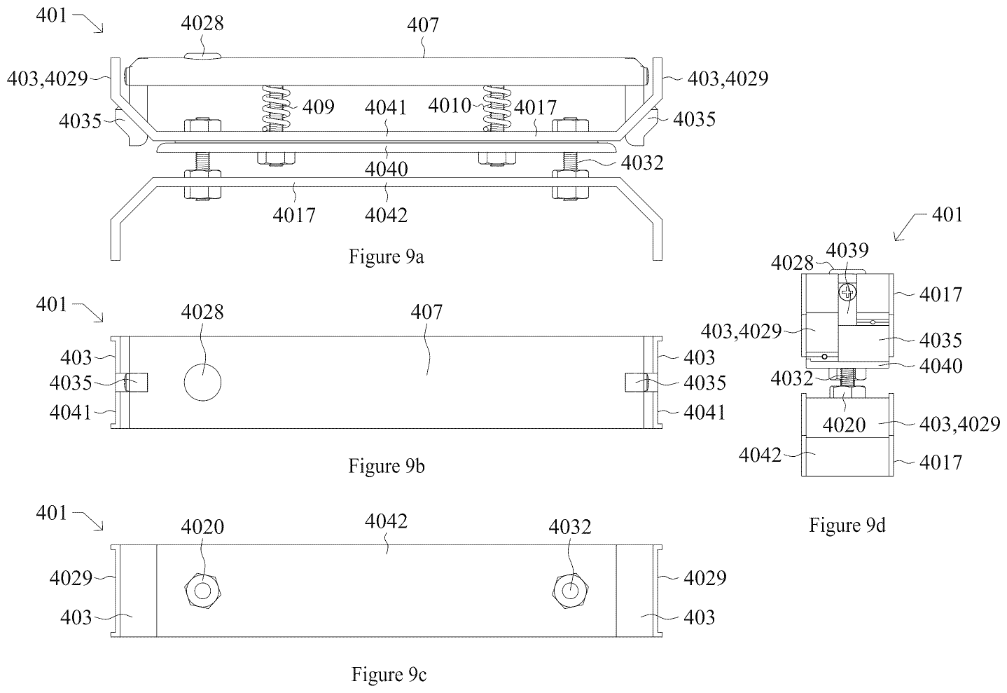

FIGS. 9a, 9b, 9c, and 9d show front, top, bottom, and side elevations of the MTT 401, respectively.

FIG. 9a shows the front elevation of MTT 401. The MTT 401 tool is comprised of four primary elements that are coupled to one another and are configured to couple to a device suspension cable 405 (not shown). The present exemplary embodiment is one of several embodiments that employ the same principles to elevate/lower a suspended coupled device (not shown) to a specified mounting height while maintaining the device plumb, and ready to be trimmed.

The MTT elements from the top to the bottom include:
A Depressible Bar 407
A Top Horizontal Structure 4041
A Friction Pressure Plate, 4040 and
A Bottom Horizontal Structure 4042

The depressible bar 407 can couple to a least one vertical plunger 409. The plunger 409 at its opposite end can couple to a friction pressure plate 4040. The plunger 409 extends downward from the bottom surface of the depressible bar 407, through a bore (not shown) in the top horizontal structure 4041, to at least the top surface of the friction pressure plate 4040.

The friction pressure plate 4040 is configured to apply friction pressure on a horizontal section of a suspension cable section that is coupled to a suspended device below. The suspension cable section (not shown) extends horizontally along the longitudinal width of the MTT1 between the bottom surface of the top horizontal structure 4041 and the top surface of the friction pressure plate 4040. When no pressure is applied on the depressible bar 407, at least one pressure exerting device 4010 maintains the depressible bar 407 fully extended upwardly.

FIG. 9a shows the plunger 409 position inside a pressure exerting spring 4010, wherein the pressure exerting spring 4010 is shown positioned between the bottom side of the depressible bar 407 and the top surface of the top horizontal structure 4041. The pressure exerting spring 4010 maintains the plunger 409 in the fully extended upward position.

The depressible bar 407 is shown coupled to cable grippers 4035. The cable grippers 4035 can extend from the depressible bar 407 downward and sideways through the top horizontal structure 4041 vertical extension member 403. The cable gripper 4035 can terminate at or in proximity to the outwardly facing surface 4029 of the top horizontal structure 4041 vertical extension member 403. When no pressure is exerted on the depressible bar 407, a cable gripper 4035 surface is configured to grip a section of a suspension cable with a coupled device below stopping the suspension cable section's vertical mobility.

When an installer exerts pressure on the depressible bar 407, gaps open between the cable gripper 4035 surfaces and the outwardly facing surfaces 4029 of the vertical extension members 403. Gaps also open between the top surface of the friction pressure plate 4040 and the bottom surface of the top horizontal structure 4041. The suspension cable is routed through the gaps to enable the subsequent operation of the MTT 401.

The top horizontal structure 4041 shown is positioned below the depressible bar 407 having vertical extension members 403 at both ends oriented upwardly. The profile of the top (and bottom) horizontal structure 4041 can be in the shape of the letter “U” where the side flanges can be configured to act as stiffeners 4017 to resist bending. The stiffeners 4017 can also act as siderails to prevent the suspension cable's lateral mobility beyond the width of the top and bottom horizontal structures 4041, 4042. The top horizontal structure 4041 is fixed to the bottom horizontal structure 4042 by at least one rod 4032 having a pre-determined spacing between the two. The friction pressure plate 4040 is positioned between the top and the bottom horizontal structures 4041, 4042.

The friction pressure plate 4040 shown is an elongated horizontal structure with top and bottom surfaces. The top surface of the friction pressure plate 4040 is configured to press against the bottom surface of the top horizontal structure 4041. When installing a suspended device, at least one of the top surface of the friction pressure plate 4040 and the bottom surface of the top horizontal structure 4041 can apply pressure on a section of the suspension cable placed between. The pressure exerted can prevent the cable's lateral mobility.

The bottom horizontal structure 4042 shown is positioned below the friction pressure plate 4040 having vertical extension members 403 at both ends oriented downwardly. The bottom horizontal structure 4042 profile can also be in the shape of the letter “U”. The side flanges can act as structural stiffeners 4017 to resist bending. The stiffeners 4017 can also act as siderails to prevent the suspension cable's lateral mobility beyond the width of the bottom horizontal structure 4042. The bottom horizontal structure 4042 is fixed to the top horizontal structure 4041 by at least one rod 4032 having pre-determined spacing between.

FIG. 9b shows the top view of MTT 401. The depressible bar 407 is shown between the vertical extension members 403 of the top horizontal structure 4041. In at least one embodiment a bubble level 4028 coupled to the bar's top surface can enable an installer to plumb the coupled device below. At opposite sides of the depressible bar, coupled cable grippers 4035 extend outward beyond the exterior surfaces of the top horizontal structure 4041 vertical extension member 4035 (full view concealed). The cable gripper 4035 is configured to grip the cable that extends from the support structure above down to the coupled device below.

FIG. 9c shows the bottom view of MTT 401. The bottom view shows the bottom horizontal structure 4042 with the vertical extension members 403 at both ends configured to extend downward. During the installation of a suspended device, suspension cable sections from above and below abut the outwardly facing surfaces 4029 of the vertical extension members 403. Spaced apart nuts 4020 shown are configured to couple to rods 4032 that couple the bottom horizontal structure 4042 to the top horizontal structure 4041.

The rods 4032 maintain a pre-determined gap between the two horizontal structures 4041, 4042. The bottom surface of the bottom horizontal structure 4042 is configured as a grip surface for an installer's fingers to lift or lower a coupled device. The installer lifts and lowers the coupled device while simultaneously exerting pressure with his/her palm on the depressible bar 407 above.

FIG. 9d shows the side views of MTT 401. The figure shows a top horizontal structure 4041 coupled to a bottom horizontal structure 4042 by a rod 4032 with a friction pressure plate 4040 positioned between the two elements 4041, 4042 secured in place with a nut 4020 below. The friction pressure plate 4040 is shown coupled to the bottom surface of the top horizontal structure.

The elements shown in the top horizontal structure include a cable gripper 4035, the outwardly facing surface 4029 of a vertical extension member 403, a bubble level 4028, and structural stiffeners 4017. The elements shown with the bottom horizontal structure include the outwardly facing surface 4029 of a vertical extension member 403, and structural stiffeners 4017.

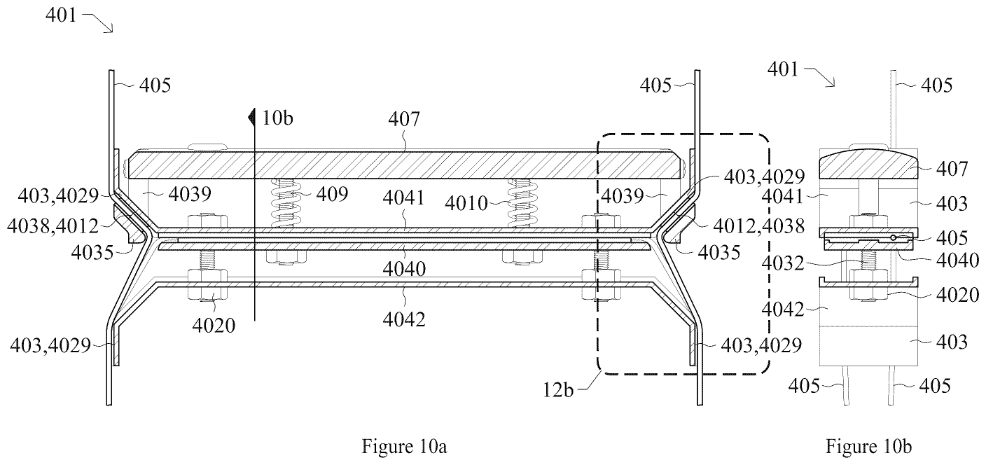

FIG. 10a shows a longitudinal vertical section of the MTT with suspension cable sections coupled by cable grippers to the MTT's structure and FIG. 10b shows a corresponding transverse vertical section of the MTT.

FIG. 10a shows a longitudinal vertical section of the MTT 401 with suspension cable 405 section gripped by the cable grippers 4035 at opposite ends of the MTT 401. The suspension cable 405 sections are coupled to the structure above (not shown). From the above structure the suspension cable 405 sections extend between the MTT's 401 cable grippers 4035 gripping surface and the outwardly facing surface 4029 of the vertical extension member 403, down to support the weight of a suspended device (not shown). The cable grippers 4035 of the MTT 401 are configured to control the vertical mobility of the suspension cable 405 sections with a coupled device. By controlling the suspension cable 405 sections' vertical mobility, the coupled device can be lifted and lowered to a specified mounting height elevation.

Cable grippers 4035 are comprised of gripper's arms 4039 that are coupled to gripping surfaces 4012. The gripping surfaces 4012 are configured to abut opposing surfaces of a top horizontal structure 4041 vertical extension member's 403 outwardly facing surface 4029. The cable grippers 4035 coupled to the depressible bar 407 extend through openings in the vertical extension members 403, terminating beyond the outwardly facing surface 4029 of the vertical extension member 403 with the gripping surfaces 4012.

In at least one embodiment the gripper's 4035 gripping surface 4012 and/or the opposing side gripping surface 4012 can receive a veneer of high friction material 4038 and/or can display at least one protrusion (not shown) that further increases the surface's resistance to at least one of a suspension cable's 405 vertical and lateral mobility. It is noted that the MTT 401 is configured to have at least one of a high friction gripping surface 4038 and/or a protrusion that can alter the suspension cable's 405 linearity, applying frictional pressure on the suspension cable 405 to prevent the cable's 405 vertical and/or horizontal mobility.

The MTT 401 is configured to enable raising/lowering, plumbing, and trimming a device coupled to suspension cable 405 sections. The MTT 401 tool's operation is simple to use. An installer can place his/her palm on the depressible bar 407, while the same hand's fingers grip the bottom surface of the bottom horizontal structure 4042. During the operation of the MTT 401 the installer exerts pressure on the depressible bar 407, and holding the MTT 401 maintains vertical motion to deliver the suspended device to a specified mounting height.

When pressure is exerted on the depressible bar 407, a gap opens between the surface of the cable gripper 4035 facing the depressible bar 407 and the outwardly facing surface 4029 of the vertical extension member 403. A single installer can then with one hand exert pressure on the depressible bar 407 and place the suspension cable 405 section between the gripping surfaces 4012. Then by continuing exerting pressure on the depressible bar 407 the installer can lift and lower the coupled device to a specified mounting height. It is noted that an installer can use the bubble level 4028 shown coupled to the top of the depressible bar 407 to plumb the suspended coupled device below the MTT 401.

When the pressure exerted on the depressible bar 407 is released, the suspension cable 405 sections are pressed by the gripping surfaces 4012 of the cable gripper 4035 and the outwardly facing surface 4029 of the top horizontal structure 4041 vertical extension members 403. It is noted that when pressure is exerted on the depressible bar 407, the cable sections are locked in place, thus the installer's hands are free to couple the cable sections 405 above the device fasteners.

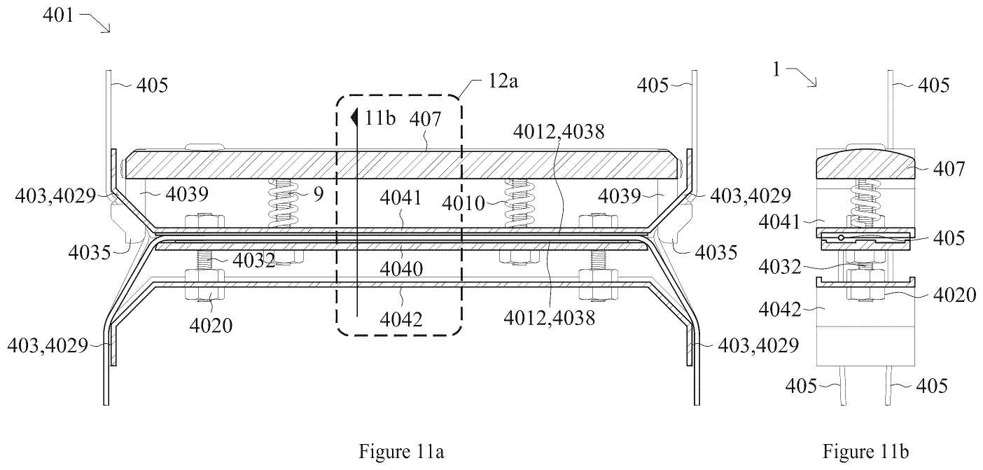

The present figure also shows cable sections 405 entering the MTT 401 from below. FIG. 11a addresses the cable sections' functionality in more detail. It is noted that in at least one embodiment of the MTT 401, the suspension cable 405 is unitary having two mounting points to a structure above.

FIG. 10a also shows other elements including the depressible bar 407 coupled to plungers 409 that are disposed inside pressure exerting devices 4010, a pressure friction plate 4040 positioned between the top horizontal structure 4041 and the bottom horizontal structure 4042. Rods configured to fixedly couple the top horizontal structure 4041 to the bottom horizontal structure 4042 maintain a gap between the two horizontal structures 4041, 4042 to enable vertical travel room for the friction pressure plate 4040.

It is noted that cable grippers 4035 are configured to allow vertical mobility of a suspended device coupled from below when pressure is applied on the depressible bar 407. When the pressure exerted on the depressible bar is released, friction pressure applied by at least the cable grippers on the vertical suspension cable 405 sections maintains the elevation height of the device suspended below the MTT 401.

It is further noted that the MTT 401 coupled to the cable grippers 4035 enables an installer to apply minimal pressure on the depressible bar 407 to lift/lower a coupled device. The installer can release the pressure on the bar 407 at a specified mounting height, and the cable grippers 4035 prevent the coupled device's vertical travel. Then, while the coupled device is fixedly hung, the installer can secure the two cable sections at both sides of the device to one another by coupling fitting (not shown), and can remove and re-use the MTT 401.

FIG. 10b shows a corresponding transverse vertical section of the MTT. The section is cut between the MTT's 401 plunger (not shown) and a spacing rod 4032 directed toward a cable gripper 4035. The arm 4039 of the cable gripper 4035 shown extends through an opening in the interior surface 4015 of the vertical extension member 403 of the top horizontal structure 4041 to the other side. At the other side, the gripping surface 4012 of the cable gripper 4035 presses against the outward facing surface of the vertical extension member 4035 of the top horizontal structure (not shown).

In the foreground, a nut 4020 shown secures a spacing rod 4032 that couples the top horizontal structure 4041 to the bottom horizontal structure 4042. The rod 4032 extends from the top surface of the top horizontal structure 4041 to at least the top surface of the bottom horizontal structure 4042. The present figure shows the spacing rod 4032 extending through the bottom horizontal structure 4042 secured by a nut 4020 from below and above the web of the bottom horizontal structure 4042.

The spacing rod 4032 is configured to maintain fixed spacing between the top and bottom horizontal structures 4041, 4042. The friction pressure plate's 40 design is configured to bypass the spacing rods 4032 unobstructed when pressure is exerted on the depressible bar 407. FIG. 4d describes in more detail the friction pressure plate's functionality 40.

FIG. 10b also shows a suspension cable 405 wedged between at least one high friction surface of a friction pressure plate 4040 and a bottom surface of a top horizontal structure 4041. The suspension cable 405 is shown extending downward from the gripping side of the friction pressure plate 4040. On the opposite side and beyond, a suspension cable 405 section extending down from the above structure abutting the outwardly facing surfaces of the top and bottom horizontal structures 4041, 4042 vertical extension members 403 to the below. A section of the suspension cable 405 is concealed from view by the vertical suspension member 403, showing the suspension cable 405 within the spacing gap formed by the spacing rods 4032 between the top and bottom horizontal structures 4041, 4042.

FIG. 11a shows a longitudinal vertical section across the MTT's side facing the MTT's friction pressure plate, and FIG. 11b shows a corresponding transverse vertical section across the MTT.

FIG. 11a shows a longitudinal vertical section of the MTT 401 across the pressure friction plate 4040 with suspension cable 405 section gripped by the cable grippers 4035 shown at the opposite side of the MTT 401. The suspension cable 405 sections are coupled to the structure above (not shown). From the above structure the suspension cable 405 sections extend between the MTT's 401 cable grippers 4035 gripping surface and the outwardly facing surfaces 4029 of the vertical extension members 403 of the top and bottom horizontal structures 4041, 4042 down to support the weight of a suspended device (not shown).

The cable sections 405 extending down from the vertical extension members 403 of the MTT 401 extend through device fasteners (not shown) that support the weight of the coupled device. The suspension cable sections 405 then extend upwardly paralleling the downwardly cable section to abut the outwardly facing surfaces of the vertical extension members 403 of the bottom horizontal section 4042. The two-suspension cable sections 405 then merge between the top face of the friction pressure plate 4040 and the bottom surface of the top horizontal structure 4041.

The friction pressure plate 4040 couples to the depressible bar 407 on top of the MTT 401 by plungers 409. When an installer exerts pressure on the depressible bar 407, a gap forms between the friction pressure plate 4040 and the bottom surface of the top horizontal structure 4041. To initialize the MTT's 401 operation, an installer can exert pressure on the depressible bar 407 and simultaneously place in position cable sections 405 between the friction pressure plate 4040 and the top horizontal structure 4041 and between the cable gripper 35 and the vertical extension members 403 outward facing surfaces 4029.

The horizontally oriented cable section 405 is disposed between the opposite ends of the vertical extension members 403 of the MTT 401. The horizontal suspension cable section is disposed on the surface of the friction pressure plate 4040. This cable section 405 is primarily configured as a contact surface to elevate the coupled MTT's suspended device to a specified mounting height. The MTT 401 with the coupled device can be lowered to mounting height by gravity force. It is noted that the suspended device mounting height trimming is done by elongating or shortening the length of the suspension cable sections 405 below the MTT 401.

At least one top of a friction pressure plate 4040 and a bottom of a top horizontal structure 4041 can be configured to have a high friction surface 4012. In at least one embodiment the gripping surface 4012 of a friction pressure plate 4040 top surface and/or the bottom surface of a top horizontal structure 4041 can receive a veneer of high friction material 4038. Further, in at least one embodiment, at least one protrusion (not shown) coupled can increase the surface's resistance on the suspension cable 405 extending across the MTT 401.

It is also noted that at least one of the friction pressure plate 4040, the bottom surface of the top horizontal surface, a cable gripper, and the outwardly facing surface of the vertical extension members can have a high friction surface 4012. The surface can include at least one protrusion that can alter a suspension cable section's 405 linearity. The high friction surfaces 4012 are configured to lock in place at least one of the vertical and lateral mobility of a suspension cable section. It is further noted that the frictional pressure applied on the suspension cable 405 is configured to prevent the cable's 405 vertical and/or horizontal mobility.

The MTT 401 is configured to enable raising/lowering, plumbing, and trimming a device coupled to suspension cable 405 sections. The MTT 401 tool’ operation is simple to use. An installer can place his/her palm on the depressible bar 407, while the same hand's fingers grip the bottom surface of the bottom horizontal structure 4042. During the operation of the MTT 401 the installer exerts pressure on the depressible bar 407 and holding the MTT 401 maintains vertical motion to deliver the suspended device to a specified mounting height. It is noted that an installer can use the bubble level 4028 shown coupled to the top of the depressible bar 407 to plumb the suspended coupled device below the MTT 401.

When the pressure exerted on the depressible bar 407 is released, the suspension cable 405 sections are pressed by the gripping surfaces 4012 of at least one of the friction pressure plate 4040, the bottom surface of the top horizontal structure 4041, the cable gripper 4035, and the outwardly facing surface 4029 of the top horizontal structure 4041 vertical extension members 403. It is noted that when pressure is exerted on the depressible bar 407, the cable sections are locked in place, thus the installer's hands are free to couple the cable sections 405 above the device fasteners.

FIG. 11a also shows other elements including the depressible bar 407 coupled to plungers 409 that are disposed inside pressure exerting devices 4010, and cable grippers 4035 coupled to the opposite ends of the depressible bar 407. Rods configured to fixedly couple the top horizontal structure 4041 to the bottom horizontal structure 4042 maintain a gap between the two horizontal structures 4041, 4042 to enable vertical travel space for the friction pressure plate 4040.

It is further noted that the MTT 401 enables an installer to apply minimal pressure on the depressible bar 407 to lift/lower a coupled device. The installer can release the pressure on the bar 407 at a specified mounting height, and the cable grippers 4035 prevent the coupled device's vertical travel. Then, while the coupled device is fixedly hung, the installer can secure the two cable sections at both sides of the device to one another by coupling fittings (not shown) and can remove and re-use the MTT 401.

FIG. 11b shows a corresponding transverse vertical section of MTT 401. The section is cut between the two MTT 401 plungers and directed toward vertical extension members 403 of the top and bottom horizontal structures 4041, 4042. Above, a depressible bar 407 is shown with a plunger 409 coupled from below. The plunger 409 at its other end couples to a friction pressure plate 4040. The present figure shows the plunger 409 inside a pressure exerting device 4010 in the form of a spring. The spring 4010 extends from the top surface of the top horizontal structure to the bottom surface of the depressible bar 407.

The friction pressure plate 407 abuts the bottom surface of the top horizontal structure 4041. At least one of the top surface of the friction pressure plate 4040 and the bottom surface of the top horizontal structure 4041 can have and/or be made of a high friction 4012 material. When no pressure is exerted on the depressible bar 407, these two high friction surfaces 4038 are configured to resist the lateral mobility of a suspension cable section 405 disposed between.

The suspension cable section shown wedged between the top surface of the friction pressure plate 4040 and the bottom surface of the top horizontal structure 4041 extends from below, and abuts both ends of the vertical extension members 403 of the bottom horizontal structure 4042 before merging above the friction pressure plate 4040. The suspension cable 405 wedged between the gripping surfaces 4012 of at least the friction pressure plate 4040 and the bottom surface of the horizontal structure 4041 enables lifting and lowering the suspended coupled device (not shown)

Beyond the plunger 409 and the opposite side of the vertical extension member 403, the suspension cable section 405 extends down from above to couple the cable gripper (not shown). From there, the suspension cable section 405 extends down abutting the outwardly facing surface (not shown) of the bottom horizontal structure 4042. A section of the suspension cable is shown between the bottom surface of the friction pressure bar 40 and the top surface of the bottom horizontal structure 4042.

Other elements shown include nuts that secure the plunger 409 to the depressible bar and nuts 4020 that secure the rods 4032 connecting the top horizontal structure 4041 to the bottom horizontal structure 4042.

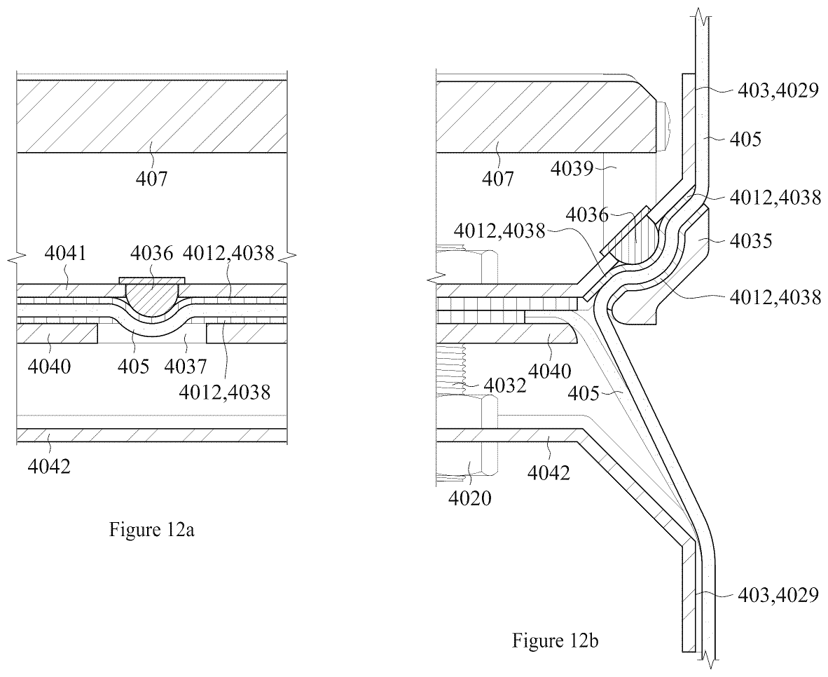

FIGS. 12a and 12b show partial enlargements of protrusions interacting with friction pressure plate and cable gripper assemblies, providing resistance against suspension cable mobility.

In at least one embodiment, at least one protrusion can be disposed on a surface that is configured to make contact with the suspension cable 405. The protrusion 36 can be on a surface of a friction pressure plate 4040, a bottom surface of the top horizontal structure 4041, a gripping surface of a suspension cable gripper 4035, and on a vertical extension member 403 gripping surface 4012. The protrusion 36 can be configured to force the suspended cable 405 through an opening to further increase the restraint against vertical mobility when no pressure is applied on the depressible bar 407.

FIG. 12a shows a vertical section of a partial enlargement of the MTT 401 with a protrusion 4036 protruding downward from the top horizontal structure 4041. On the opposite side to protrusion 4036, a reciprocating bore 4037 is configured to receive at least one of the suspension cable 405, and the protrusion 4036. The suspension cable 405 is shown wedged between the friction pressure plate 4040 and the bottom surface of the top horizontal structure 4041.

The gripping surfaces 4012 of the present embodiment are of a veneer friction material 4038 of high friction that is coupled to at least one surface of the friction pressure plate 4040 and the bottom surface of the top horizontal structure 4041. In another embodiment, at least one surface displaying high friction properties can directly apply friction pressure on the suspension cable 405. Other elements shown include a section of the depressible bar 407 above, and a section of the bottom horizontal structure 4042 below.

It is noted that the linearity of the suspension cable 405 horizontally wedged between the friction pressure plate 4040 and the bottom surface of the top horizontal structure 4041 is altered when a protrusion 4036 exerts pressure on the suspension cable 405. As a result, the pressure on the suspension cable 405 against lateral mobility increases. When pressure is exerted on the depressible bar 407, the suspension cable 405 can laterally move, allowing the plumbing of a device coupled to the suspension cable 405 below.

FIG. 12b shows a vertical section of a partial enlargement of the MTT 401 vertical extension members 403 with a cable gripper 4035 coupled to the outwardly facing surface 4029 of the top horizontal structure 4041 vertical extension member 403. A suspension cable 405 received from the above structure is shown abutting the outwardly facing surface 4029 of the top horizontal structure 4041 vertical extension member 403. The suspension cable shown extends down to become wedged between the member's 403 outwardly facing surface 4029 and the gripping surface 4012 of the cable gripper 4035.

Below the cable gripper 4035, the suspension cable 405 extends down to abut the outwardly facing surface 4029 of the bottom horizontal structure 4042 vertical extension member 403 and then continues down to support the weight of a coupled device (not shown). The suspension cable gripper 4035 shown is configured to stop the vertical mobility of a device coupled below the MTT 401 during installation.

The present figure shows a protrusion coupled to the vertical extension member of the top horizontal structure. The protrusion is shown extending outwardly toward a reciprocating cavity in the face of the gripping surface of the suspension cable gripper 4035. A suspension cable 405 is shown between the outwardly facing surface 4029 of the vertical extension member 403 and the gripping surface 4012, 4038 of the suspension cable gripper 4035. The present figure shows both surfaces made of and/or having high friction properties 4012, 4038.

The suspension cable gripper 4035 is shown coupled to the depressible bar 407. When pressure is exerted on the depressible bar 407, a gap forms between the gripping surfaces 4012, 4038 of the suspension cable gripper 4035 and the outward facing surface 4029 of the vertical extension member 403 of the top horizontal structure 4041. The suspension cable is placed in the gap during the initial installation and then re-opens when the device coupled below is lifted/lowered to a specified mounting height.

It is noted that when no pressure is exerted on the depressible bar 407, the cable gripper 4035 abuts the outward facing surface of the vertical extension member of the top horizontal structure. When a suspension cable is wedged between the two surfaces, the suspension cable's vertical mobility is stopped. It is also noted that when at least one protrusion is coupled to at least one surface that is configured to exert friction pressure on the suspension cable 405 gripped by the cable gripper 4025, the resistance against the suspension cable's vertical mobility can increase.

Other elements shown include the depressible bar 407 above, the cable grippers' arm 4039, the friction pressure plate 4040, the bottom horizontal structure 4042, and a partial section of the rod 4032 coupling by nuts 4020 to the top horizontal structure 4041 to the bottom horizontal structure 4042.

### ELEMENT LIST

| | | | |
|---|---|---|---|
| 1, 401 | Mechanical Trimming Tool | 23 | Guiding Leader |
| 2 | Elongated Horizontal | 24 | Roller |
| | Structure | | |
| 3, 403 | Vertical Extension Member | 25 | Insertion Slot |
| 4 | Tab | 26, 4026 | Fastener |
| 5, 405 | Suspension Cable | 27 | Eye Loop |
| 6 | Coupling Device | 28, 4028 | Bubble Level |
| 7, 407 | Depressible Bar | 29, 4029 | Exterior Side |
| | | | Surface |
| 8 | Plunger Extension | 30 | Light Emitting |
| | | | Device |
| 1, 401 | Mechanical Trimming Tool | 23 | Guiding Leader |
| 9, 409 | Plunger | 31 | Mechanical |
| | | | Pressure Exerting |
| | | | Latching Device |
| 10, 4010 | Pressure Exerting Device | 4029 | Vertical extension |
| | | | member |
| 11 | Latching Device | 4032 | Rod |
| 12, 4012 | Non-slip Material | 4033 | Mounting Points |
| 13 | Hardened Backing Surface | 4035 | Cable Gripper |
| 14 | Channel | 4036 | Protrusion |
| 15, 4015 | Interior Side | 4037 | Bore |
| 16 | Exterior Side Surface | 4038 | High Friction |
| | | | Material |
| 17, 4017 | Stiffener | 4039 | Arm |
| 18 | Passthrough Opening | 4040 | Friction Pressure |
| | | | Plate |
| 19 | Orientation Specific Hub | 4041 | Top Horizontal |
| | | | Structure |
| 20, 4020 | Nut | 4042 | Bottom Horizontal |
| | | | Structure |
| 21, 4021 | Device | 4043 | Cable Coupler |
| 22, 4022 | Support Structure | | |

1. A trimming tool for use in mounting a suspended device, the trimming tool comprising:
a top horizontal structure having extension members;
a bottom horizontal structure coupled to, and disposed under, the top horizontal structure;
a friction pressure plate disposed between the top horizontal structure and the bottom horizontal structure;
a pressure exerting device that applies a force to hold a top surface of the friction pressure plate against a bottom surface of a top member structure;
a depressible bar coupled to the friction pressure plate;
cable grippers coupled to the depressible bar on opposite ends and extending outwardly beyond the vertical extension members of the top horizontal structure, the cable grippers abut outwardly facing surfaces of the vertical extension members, the pressure exerting device exerts pressure on a cable gripper surface that abuts an outwardly facing surface of the vertical extension member; and
a suspension cable having a first section that originates from above is disposed between the exterior faces of the vertical extension members and a gripper surface that faces the depressible bar, a second section of the suspension cable that originates from a device coupled below converges with the first section between the friction pressure plate and a bottom surface of the top horizontal structure, wherein
pressure exerted on the depressible bar opens a gap between the friction pressure plate and the bottom surface of the top member structure and between the cable grippers and the outward facing surfaces of the top horizontal structure to enable the suspension cable to be inserted in the gap.

2. The trimming tool of claim 1, wherein at least one of the friction pressure plate, a bottom side of the top horizontal structure, the cable gripper, and one of the outwardly facing surfaces of a vertical extension member of a top horizontal structure has a high friction surface, the high friction surface having a greater coefficient of friction than a flat metal surface.

3. The trimming tool of claim 1, further comprising at least one protrusion that extends from a surface of at least one of the friction pressure plate, the top horizontal structure, the cable grippers, and the vertical extension member, the at least one protrusion is sized to increase friction on the suspension cable that abuts the at least one protrusion.

4. The trimming tool of claim 1, wherein the cable grippers are configured to prevent vertical mobility of a coupled device that is suspended below by the suspension cable.

5. The trimming tool of claim 1, wherein the friction pressure plate is configured to at least maintain the suspended device in fixed position once the suspended device is plumbed.

6. The trimming tool of claim 1, wherein depression of the depressible bar enables a raising/lowering of the suspended device so the suspended device can be set to a specified mounting elevation.

7. The trimming tool of claim 1, further comprising a level bubble coupled to the trimming tool to provide a visual indication to an installer to plumb the suspended device.

8. A trimming tool for use in mounting a suspended device, the trimming tool comprising:
a top horizontal structure having extension members;
a bottom horizontal structure coupled to, and disposed under, the top horizontal structure;
a friction pressure plate disposed between the top horizontal structure and the bottom horizontal structure;
a pressure exerting device that applies a force to hold a top surface of the friction pressure plate against a bottom surface of a top member structure;
a depressible bar coupled to the friction pressure plate;
cable grippers coupled to the depressible bar on opposite ends and extending outwardly beyond the vertical extension members of the top horizontal structure, the cable grippers abut outwardly facing surfaces of the vertical extension members, the pressure exerting device exerts pressure on a cable gripper surface that abuts an outwardly facing surface of the vertical extension member; and
a suspension cable having a first section that originates from above is disposed between the exterior faces of the vertical extension members and a gripper surface that faces the depressible bar, a second section of the suspension cable that originates from a device coupled below converges with the first section between the friction pressure plate and a bottom surface of the top horizontal structure, wherein
depression of the depressible bar enables a raising/lowering of the suspended device so the suspended device can be set to a specified mounting elevation.

9. The trimming tool of claim 8, wherein a resilient force applied by the pressure exerting device is lower than a hand clenching force of a hand of an installer, such that when the clenching force is applied to the depressible bar at least one section of the suspension cable is placeable against a high friction surface of the trimming tool by the other hand of the installer.

10. The trimming tool of claim 8, wherein at least two sections of the suspension cable pass through at least two device suspension fasteners coupled to the suspended device below.

11. The trimming tool of claim 10, wherein the at least two suspension fasteners are distally set apart from one another.

12. The trimming tool of claim 8, wherein respective lengths the cable sections suspending the suspended device are settable by a raising or lowering of the trimming tool during installation of the suspended device.

13. The trimming tool of claim 8, wherein pressure exerted on the depressible bar urges the friction pressure plate toward the bottom horizontal structure.

14. The trimming tool of claim 8, wherein the trimming tool is configured to be removable after the suspended device is set to a predetermined height and the suspension cable is trimmed.

15. A trimming tool for use in mounting a suspended device, the trimming tool comprising:
a top horizontal structure having extension members;
a bottom horizontal structure coupled to, and disposed under, the top horizontal structure;
a friction pressure plate disposed between the top horizontal structure and the bottom horizontal structure;
a pressure exerting device that applies a force to hold a top surface of the friction pressure plate against a bottom surface of a top member structure;
a depressible bar coupled to the friction pressure plate;
cable grippers coupled to the depressible bar on opposite ends and extending outwardly beyond the vertical extension members of the top horizontal structure, the cable grippers abut outwardly facing surfaces of the vertical extension members, the pressure exerting device exerts pressure on a cable gripper surface that abuts an outwardly facing surface of the vertical extension member; and
a suspension cable having a first section that originates from above is disposed between the exterior faces of the vertical extension members and a gripper surface that faces the depressible bar, a second section of the suspension cable that originates from a device coupled below converges with the first section between the friction pressure plate and a bottom surface of the top horizontal structure, wherein
a release of pressure applied by an installer on the depressible bar causes portions of the suspension cable to be wedged in the trimming tool so as to lock the suspended device in place and prevent horizontal and lateral movement.

16. The trimming tool of claim 15, wherein during the installation of the suspended device, at each side of the trimming tool a single cable section of the suspension cable from above abuts the trimming tool and two cable sections of the suspension cable abuts the trimming tool from below.

17. The trimming tool of claim 16, further comprising fasteners that couple together the two cable sections at each side of the suspended device.

18. The trimming tool of claim 17, wherein after the fasteners are fixed, a section of the suspension cable that is wedged in the trimming tool between the friction pressure plate and the top horizontal structure is removed.

19. The trimming tool of claim 15, wherein the suspension cable is a single cable suspended from two support mounting points and enables lowering/raising, plumbing, and trimming of the suspended device below.

20. The trimming tool of claim 15, wherein a device coupled to two fasteners is suspended by two through fastener cable sections and during installation the cable sections are free to travel through the fasteners.
